(19) United States
(12) Patent Application Publication
(10) Pub. No.: US 2011/0205532 A1
(43) Pub. Date: Aug. 25, 2011

(54) INSPECTION METHOD FOR INSPECTING CORROSION UNDER INSULATION

(75) Inventors: Hisakazu Mori, Niihama-shi (JP); Toyokazu Tada, Niihama-shi (JP); Hideo Cho, Sagamihara-shi (JP); Yuichi Machijima, Kita-ku (JP)

(73) Assignee: SUMITOMO CHEMICAL COMPANY, LIMITED, Chuo-ku, Tokyo (JP)

(21) Appl. No.: 13/126,120

(22) PCT Filed: Oct. 29, 2008
(86) PCT No.: PCT/JP2009/068938

§ 371 Date: Apr. 26, 2011

(30) Foreign Application Priority Data
Oct. 30, 2008 (JP) 2008-279795

(51) Int. Cl. G01N 21/00

(52) U.S. Cl. 356/73.1

(57) ABSTRACT

The present invention realizes an inspection method for inspecting corrosion under insulation. This inspection method according to the present invention makes it possible to inspect corrosion easily and economically in piping furnished with heat insulators. The inspection method is an inspection method for inspecting corrosion under insulation, in piping to which an heat insulator is provided, and includes providing a fiber optical Doppler sensor to the piping; and inspecting the corrosion in the piping by using the fiber optical Doppler sensor.

### TECHNICAL FIELD

The present invention relates to an inspection method for inspecting corrosion under insulation. More specifically, the present invention relates to an inspection method capable of easily and economically inspecting corrosion in piping to which a heat insulator is provided.

### BACKGROUND ART

Corrosion under insulation occurring in piping made of carbon steel, low-alloy steel, or the like is a main cause of leakage from the piping, and one of significant degradation phenomena on that should be carefully monitored in chemical plants under long-term operation.

In general, one plant is piped for such a great length as several ten kilometers in total, and such piping is usually covered with heat insulators. Therefore, it is necessary to remove the heat insulators in order to carry out visual inspection on corrosion under insulation (hereinafter, may be referred to as CUI). Such removal (detachment) of the heat insulators requires enormous man-hour and huge cost. Moreover, visual inspection after removing all the heat insulators normally ends up to find corrosion in two or three pipes per 1000 pipes. This is very inefficient. Therefore, there is a demand for development of CUI inspection technique by which inspection for piping in plant facilities that need strict explosion protection can be performed without detaching the heat insulators.

So far, various non-destructive instruction techniques have been developed for CUI inspection for piping. For example, radiograph inspection, ultrasonic flaw detection using guide wave, and the like have been developed and employed in practice.

The radiograph inspection is a testing method in which transmission strength of radiation passing through an heat insulator and piping is measured by using a radiation source and a sensor facing the radiation source, so as to evaluate whether a damage to the piping is present or not. Moreover, the radiograph inspection can provide a corrosion thinning map of piping by scanning the piping in an axial direction thereof with a scanner having the radiation source and the sensor. Thus, the radiograph inspection can provide visual information on corrosion of piping without removing the heat insulators from the piping (Non-Patent Literature 1).

The ultrasonic flaw detection is a testing method in which a guide wave (ultrasonic wave) is traveled for a long distance through piping and echoes returned from where a cross section has been changed are detected so as to evaluate whether a damage to the piping is present or not. The ultrasonic flaw detection in which a guide wave is traveled through piping makes it possible to inspect a long distance in the piping, thereby allowing speedy inspection of the piping (Non-Patent Literature 2).

### CITATION LIST

### Non-Patent Literatures

### Non-Patent Literature 1

Shunei KAWABE “Inspection on thinning in piping by using guide waves” (gaidoha wo mochiita haikan genniku kensa gijutsu), The piping engineering, Japan Industrial Publishing Co., Ltd., 2008 June, p. 19-24

### Non-Patent Literature 2

Yoshiaki NAGASHIMA, Masao ENDO, Masahiro MIKI, Kazuhiko MANIWA, “Automated Inspection on crude oil piping by using RT” (RT wo mochiita genyu haikann jidou kensa), Inspection Engineering, Japan Industrial Publishing Co., Ltd, 2006 January, p. 18-24

### SUMMARY OF INVENTION

### Technical Problem

However, these conventional inspection techniques are applicable to limited conditions.

More specifically, the radiograph inspection requires that the piping be scanned axially by the scanner in order to obtain the corrosion thinning map of the whole piping. Because of this, the radiograph inspection is applicable only to straight pipes of the piping. Moreover, the system of the radiograph inspection, such as the scanner with the radiation source and sensor, requires a space to install. Therefore, the application of the radiograph inspection is limited by complexity and narrow piping gaps in complex piping of, for example, chemical plants.

On the other hand, the ultrasonic flaw detection is disadvantaged in that the echoes occur from any cross sectional changes including not only corrosive thinning portions in the piping but also connection sections and flange section in the piping, while the ultrasonic flaw detection is capable of detecting flaws in such a long distance as several meters by long-distance transmission of the guide wave through the piping. Therefore, without knowing shapes of the piping in advance, the ultrasonic flaw detection can not accurately evaluate whether the damage is present in the piping or not. Further, the echoes from a connection section or flange section is great in echo strength. This would cause linking of the echoes, thereby producing a section where the detection is not possible due to the linkage of the echoes. Moreover, the ultrasonic flaw detection requires removal of the heat insulators from the piping.

Furthermore, these conventional inspection techniques are applicable to inspect whether or not any carrion occurs in the piping, but not applicable to monitor the piping in real time so as to evaluate a progress level of the corrosion in real time.

The present invention was accomplished in view of the following problems. A main object of the present invention is to realize an inspection method for inspecting corrosion in piping under insulation efficiently, easily, and economically.

### Solution to Problem

In order to attain the object, the present inventor diligently studied to establish an inspection method for inspecting the corrosion of piping under insulation efficiently, easily, and economically. As a result of the diligent studies, the present inventor found that corrosion in piping can be detected by using a fiber optical Doppler sensor to detect acoustic emission (which is an elastic wave and may be referred to as “AE” hereinafter) from flaking or cracking at corroded portion of the piping (hereinafter, such a corroded portion may be referred to as corrosive tubercle (sabi-kobu in Japanese). The present invention is based on this finding.

That is, the present invention provides an inspection method for inspecting corrosion under insulation, in piping to which an heat insulator is provided, the method comprising: providing a fiber optical Doppler sensor to the piping; and inspecting the corrosion in the piping by using the fiber optical Doppler sensor.

The fiber optical Doppler sensor is workable in such a wide temperature range of −200° C. to 250° C. Therefore, with the use of the fiber optical Doppler sensor, the inspection method can be applied to detect the CUI under various detection conditions. Further, the fiber optical Doppler sensor is explosion-proof so that no spark of electricity will occur from the fiber optical Doppler sensor. Thus, the fiber optical Doppler sensor can be constantly (i.e., not-temporarily) provided even in a plant having an explosion-proof area (such as a petrochemical plant). This makes it possible to perform real-time detection of AE occurring from corrosion. Therefore, the inspection on corrosion under insulation can be performed more easily. Moreover, this makes it possible to monitor the accumulated numbers of AE occurrences.

### Advantageous Effects of Invention

An inspection method according to the present invention for inspecting corrosion under insulation is arranged such that the corrosion in piping is detected by using the fiber optical Doppler sensor provided to the piping, as described above. As a result, the inspection method according to the present invention makes it possible to perform inspection on the corrosion under insulation efficiently, easily, and economically.

### BRIEF DESCRIPTION OF DRAWINGS

FIG. 1 is a block diagram illustrating Doppler effect in an optical fiber.

FIG. 2 is a block diagram illustrating an oscillation measuring device.

FIG. 3 is a waveform chart illustrating relationship between frequency of detected AE and spectrum power.

FIG. 4 is a cross sectional view schematically illustrating a mock-up piping used in Examples of the present invention.

FIG. 5 is a graph plotting the number of the AE occurrences in an early stage of the corrosion and the accumulated number of AE occurrences in Example 1.

FIG. 6 is a graph showing the number of AE occurrences detected by an FOD sensor position in a distance of 3900 mm in Example 2.

FIG. 7 is a front view schematically illustrating how to attach an FOD sensor to a flange section.

FIG. 8 is a graph plotting the numbers of AE occurrences in a pipe section and a flange section attached with the FOD sensor and accumulated numbers of AE occurrences in the pipe section and the flange section in Example 3.

FIG. 9 is a graph plotting the number of AE occurrences in a pipe in a medium stage and a late stage of the corrosion and the accumulated number of AE occurrences in the medium stage and the late stage of the corrosion in Example 4.

### DESCRIPTION OF EMBODIMENTS

One embodiment of the present invention is described below. It should be noted that the present invention is not limited to the embodiment.

In the Description of this application, an expression “in a range of from A to B” means “not less than A, but not more than B”.

In this embodiment, an inspection method of the present invention for inspecting corrosion under insulation is a method for detecting AE from piping by using a fiber optical Doppler (FOD) sensor attached to the piping, so as to detect corrosion in the piping.

The FOD sensor may be attached to any portion of the piping as long as the FOD sensor can be in contact with a surface of the piping. For the sake of better sensitivity of the FOD sensor, it is preferable to attach the FOD sensor to a pipe portion of the piping. What is meant by the “pipe portion” is “part of the piping except for shape-wise discontinuous portions such as valves, flanges, branches, etc.”. Meanwhile, the heat insulator covering the flange can be easily removed (detached) compared with heat insulators covering the other portion of the piping than the flange section. Therefore, the FOD sensor may be attached to a flange section in consideration of little labor and low cost required for attaching the FOD sensor to the flange section or removing the heat insulator from the flange section in maintenance or inspection of the FOD sensor.

The FOD sensor may be attached to the piping in any way, provided that the FOD sensor is in contact with the surface of the piping. For example, the FOD sensor can be attached to a pipe section by using a U-bolt, while the FOD sensor can be attached to a flange section by using a clamp. Moreover, the FOD sensor may be attached to the piping by using a commercially-available adhesive medium, which may be, for example, sonny coat (product name: made by Nichigo Acetylene Co., Ltd.) available for use in ultrasonic flaw detection, an adhesive such as Aron-Alpha (product name: made by Konishi Co., Ltd.), or the like. Furthermore, a chemical plant may be built such that the FOD sensor is attached to the piping before the heat insulator is attached to the piping. As an alternative, the FOD sensor may be attached to the piping after the chemical plant is built. In short, the FOD sensor may be attached to the piping at any timing before the inspection method for inspecting the corrosion under insulation is carried out.

To be able to efficiently inspect such a long distance of piping for the corrosion under insulation, it is preferable to provide a plurality of the FOD sensors to the piping. There is no particular limitation in terms of the number of the FOD sensors attached to the piping, provided that the FOD sensors can appropriately detect AE from the piping. Thus, the number of the FOD sensors can be determined according to such conditions as the length of the piping to be inspected.

The inspection method according to the present invention allows to evaluate the corrosion in terms of a progress level thereof by measuring the accumulated number of the AE occurrences. Because the FOD sensor has a very high durability, it is preferable that the FOD sensor is constantly provided to the piping in order to save the labor and cost for removing the heat insulator from the piping.

In the following, the FOD sensor and an AE detection method employed in the inspection method of the present invention for inspecting the corrosion under insulation are described in details.

[1. FOD Sensor]

The FOD sensor is a sensor that utilizes the Doppler effect of an optical fiber. The FOD sensor can detect a change in frequency of light incident to the optical fiber. By this, the FOD sensor can detect strain (such as elastic wave, stress change, etc.) applied to the optical fiber.

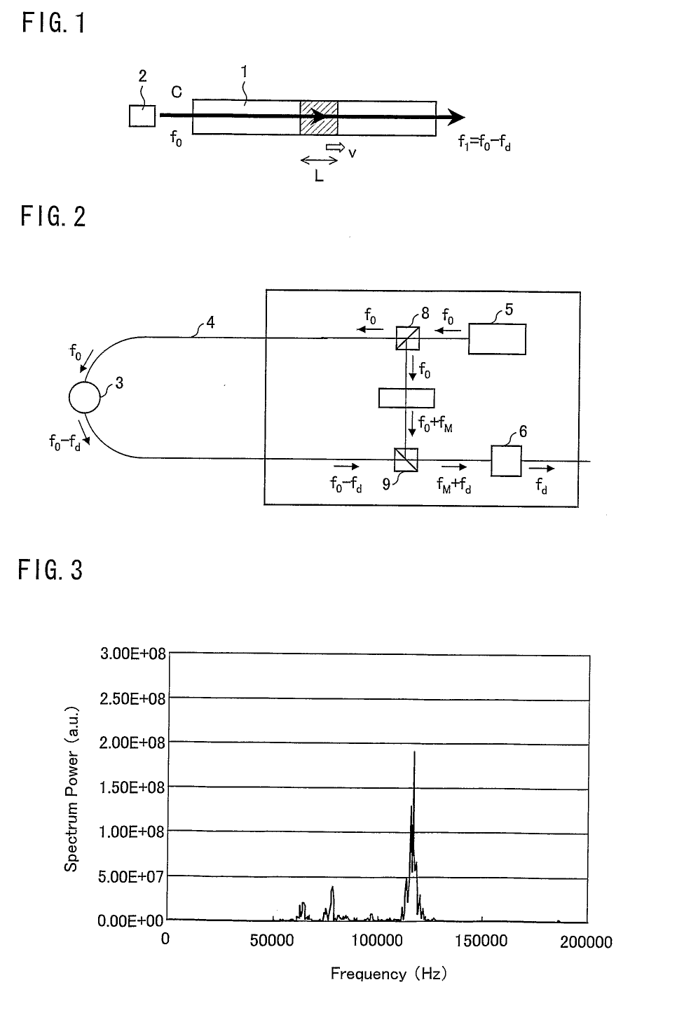

Here, the “Doppler effect of the optical fiber” is explained referring to FIG. 1, which is a block diagram for explaining the Doppler effect of the optical fiber. For example, put that an optical fiber 1 is elongated by a length L at an elongation speed v when the optical fiber 1 receives an optical wave of sound velocity C and frequency f₀. Assuming that the frequency of the incident light is thereby modulated from f₀ to f₁ due to the Doppler effect, the frequency f₁ after the modulation can be expressed as Formula (1) by using Doppler's Formula:

$$\begin{matrix}Math . 1 & \\ {f}_{1} = \frac{C - v}{C} {f}_{0} = {f}_{0} - \frac{v}{C} \cdot {f}_{0} & ( 1 )\end{matrix}$$

where f₀ is the frequency of the incident light, f₁ is the frequency after the modulation, C is sound velocity, and v is an elongation speed of the optical fiber. If the modulation modulates the frequency f₀ of the incident light to the frequency f₁ by f_{d} in Formula (1), then the frequency modulation f_{d} of the optical fiber can be expressed as Formula (2):

$$\begin{matrix}Math . 2 & \\ {f}_{d} = {f}_{0} \cdot \frac{v}{C} & ( 2 )\end{matrix}$$

where f₀ is the frequency of the incident light, f_{d} is the frequency modulation of the optical fiber, C is sound velocity, and v is an elongation speed of the optical fiber. Using the formula (3), which is a formula of wave, the frequency modulation f_{d} of the optical fiber can be expressed as Formula (4):

Math. 3

C=f₀·λ (3)

where f₀ is the frequency of the incident light, C is sound velocity, and • is wavelength.

$$\begin{matrix}Math . 4 & \\ {f}_{d} = {f}_{0} \cdot \frac{v}{C} = \frac{{f}_{0}}{C} \cdot v = \frac{1}{λ} \cdot \frac{d L}{d t} & ( 4 )\end{matrix}$$

where f₀ is the frequency of the incident light, f₁ is the frequency after the modulation, C is sound velocity, t is time, L is a length of the optical fiber, and dL/dt is a length change of the optical fiber over time. Formula (4) indicates that the elongation speed of the optical fiber is detectable as the frequency modulation of the optical wave. That is, by monitoring the frequency modulation f_{d} of the optical fiber, it is possible to detect the strain (elastic wave, stress change, etc.) applied on the optical fiber.

Moreover, the FOD sensor is configured such that the optical fiber is coiled up so as to have a large L value in Formula (4). With a large L value, the FOD sensor has a better sensitivity and is also sensitive in all directions.

[2. AE Detection Method]

In order to detect AE, the inspection method of the present invention for inspecting the corrosion under insulation employs an oscillation measuring device that includes the FOD sensor. In the following, the oscillation measuring device that includes the FOD sensor is described referring to the block diagram in FIG. 2. In addition to the FOD sensor 3, the oscillation measuring devices mainly includes an optical fiber 4 connected to the FOD sensor 3, a light source for supplying input light to the optical fiber 4, and a detector 6 for detecting frequency modulation that occurs between the input light from the light source 5 and output light from the optical fiber 4.

The light source 5 is a laser using a semiconductor, gas, or the like. The light source 5 can radiate a laser beam (coherent light) to the optical fiber 4. The input light from the light source 5 is not particularly limited in terms of its wavelength and can be in visible light range or infrared band. It is preferable that the light source 5 be a semiconductor laser of 1550 nm in wavelength because such a semiconductor laser is easily available.

The detector 6 can detect the frequency modulation that occurs between the input light from the light source 5 and the output light from the optical fiber 4. It is preferable that the detector 6 be of low-noise type that can detect AE.

The oscillation measuring device further includes AOM (Acoustic Optical Modulator) 7, a half mirror 8 for sending part of the input light to the AOM 7 at which the input light is modulated, and a half mirror 9 for sending to the detector 6 the input light modulated by the AOM 7. The AOM 7 has a conventionally well-known configuration and is capable of modulating the frequency f₀ of the input light to a frequency (f₀+f_{M}) where f_{M} is an amount of change in the frequency and may be positive or negative.

The optical wave of frequency f₀ inputted to the FOD sensor 3 from the light source 5 via the optical fiber 4 is modulated to a frequency (f₀−f_{d}) when the FOD sensor 3 receives AE occurred due to flaking, cracking, or the like caused by the corrosion in the piping. The modulated optical wave is supplied to the detector 6 via the optical fiber 4. The detector 6 detects a modulation component (frequency modulation of the optical fiber) f_{d} according to optical heterodyne interferometry. The modulation component f_{d} thus detected is converted to a voltage V by an FV converter (not illustrated). The oscillation measuring device outputs the voltage V.

According to frequency analysis, an original wave form data of the voltage V outputted from the oscillation measuring device is converted to extracted data plotted in FIG. 3 in which the vertical axis indicates frequency and the horizontal axis indicates the spectrum power. The frequency analysis uses fast Fourier transformation (FFT).

In the inspection method of the present invention for inspecting the corrosion under insulation, it is preferable that the fiber optical Doppler sensor be provided to a flange section of the piping. It is easy to remove an heat insulator from the flange section to which the heat insulator is provided. Thus, the removal of the heat insulator from the flange section does not need enormous man-hour and huge cost. Thus, it is possible to perform the inspection on the corrosion under insulation easily and economically. Moreover, if the fiber optical Doppler sensor is constantly attached to the piping, maintenance and inspection of the sensor can be performed easily.

In the inspection method of the present invention for inspecting the corrosion under insulation, it is preferable that a plurality of the fiber optical Doppler sensors be provided to the piping. The fiber optical Doppler sensor is sensitive to frequencies in a wide range of 1 Hz to 1 MHz. Meanwhile, AE occurring from corrosion is an elastic wave of a relatively low frequency, in a range of audible frequencies to 500 kHz, and is propagated in a large area. Thus, by providing the plurality of the fiber optical Doppler sensors to the piping, it becomes possible to detect corrosion in the entire piping. Moreover, this does not require scanning the entire piping, unlike the radiograph inspection. Therefore, the inspection can be performed efficiently with this arrangement.

In the inspection method of the present invention for inspecting the corrosion under insulation, it is preferable that the fiber optical Doppler sensor(s) detect acoustic emission of frequencies in a range of 10 kHz to 150 kHz. A lower frequency travels farther. Therefore, it is preferable that the fiber optical Doppler sensor(s) detect a lower frequency for the sake of better detection efficiency of the sensor(s). This allows the fiber optical Doppler sensor(s) to have a wider detectable area. As a result, the inspection on the corrosion under insulation can be performed more efficiently.

Furthermore, the inspection method of the present invention for inspecting the corrosion under insulation preferably comprises monitoring an accumulated number of acoustic emission occurrences, so as to evaluate a progress level of the corrosion. This makes it possible to perform real-time evaluation on the progress level of the corrosion. As a result, it becomes possible to repair the piping with such priority that a more severely corroded portion of the piping is given priority over a less severely corroded portion thereof. Thus, the piping can be repaired according to the progress level of the corrosion.

### EXAMPLES

The inspection method for inspecting corrosion under insulation (hereinafter, may be referred to as CUI) was evaluated in early stage, medium stage, and late stage of the corrosion. The stages of the corrosion is determined according to condition of corrosive tubercles. Corrosion is a state in which iron hydroxide (FeOOH), iron oxide (Fe₂O₃, Fe₃O₄, etc.) is adhered thinly on a surface of metal. Corrosive tubercle is a state where the corrosion forms a tubercle with moisture, oxide, etc further supplied thereto.

Here, the early stage of the corrosion is defined as a state in which no corrosive tubercle is formed yet, but corrosion adhered on a surface of piping can be confirmed visually.

The medium stage of the corrosion is defined herein as a state in which a corrosive tubercle is formed and the corrosion is more widely spread. In the medium stage, the corrosion bites into the piping more deeply. The state “the corrosion is more widely spread” is a state in which an area the corrosion completely covers the surface of the piping is 10 cm² or wider. Moreover, whether or not the corrosion bites into the piping more deeply can be confirmed by checking whether or not a corrosive tubercle is formed.

The late stage of the corrosion is defined herein as a state in which the corrosion bites into the piping further deeply and the corrosive tubercle is cracked. Here, the state in which “the corrosive tubercle is cracked” is a state where a linear crack of 1 mm or longer is confirmed on a surface of the corrosive tubercle visually.

In the following, Examples on evaluation of CUI detection methods are described.

### Example 1

### Evaluation on AE Detection in Early Stage of the Corrosion

(1. Preparation of Mock-Up Piping)

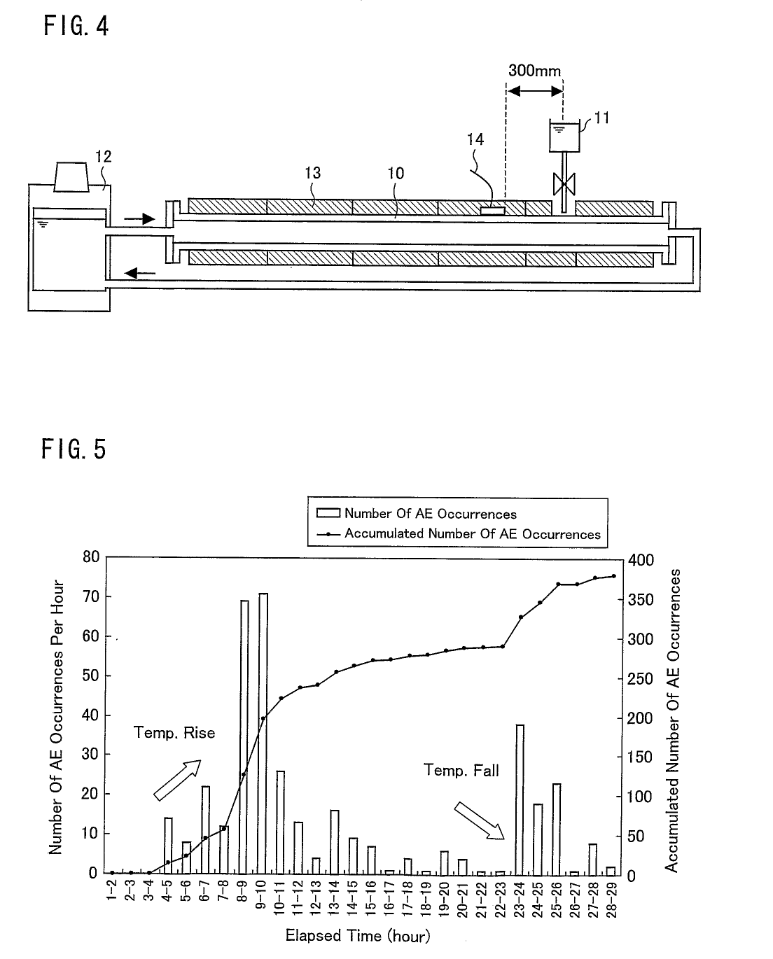

In order to evaluate the CUI detection methods using a FOD sensor, a mock-up piping as illustrated in FIG. 4 was prepared firstly.

A heat insulator 13 was attached to a pipe 10 made of carbon steel in 5 m in length. Silicone oil heated by a heating device 12 was circulated through the pipe 10. Corrosion was artificially accelerated in order to cause CUI efficiently. More specifically, the corrosion was produced as follows. Pure water was continuously dropped from a dropping device 11 to a surface of the pipe 10 in such a dropping amount that was finely adjusted to repeatedly produce a wet state and a dry state (i.e., to produce so-called “nuregawaki” state in Japanese) on the piping 10. In addition to this water dropping, dietary salt was applied to the surface of the pipe 10. Further, the silicone oil circulating through the pipe 10 was heated in a range of 60° C. to 70° C., in order to accelerate the corrosion.

(2. Evaluation of AE Detection)

About 1 month later from the start of the artificial acceleration of the corrosion, the AE detection was evaluated in an early stage of the corrosion. The FOD sensor was a commercially available FOD sensor of coiled-up type (made by Lazoc Inc., LA-ED-S65-07-ML), which was produced by coiling up an optical fiber AE of 65 m in gauge length. As illustrated in FIG. 4, the FOD sensor 14 was firmly attached, by using a U-bolt, to a pipe section in a distance of 300 mm from the corroded portion where the corrosion was artificially produced (i.e., where the pure water was dropped on).

Heating of the silicone oil was started 3 hours later from the start of the AE measurement. After the oil temperature of the silicone oil reached 70° C., the oil temperature was kept at 70° C. for 16 hours. Then, the heating of the silicone oil was stopped to allow the oil temperature to cool down to an ambient temperature. Here, the oil temperature was a temperature displayed at the heating device 12 for heating the silicone oil. Moreover, the silicone oil was kept circulated through the pipe 10 during the AE measurement regardless of whether the silicone oil was heated or not.

FIG. 5 illustrates a graph showing the result of the AE measurement. In FIG. 5, the bar graph shows the number of the AE occurrences per hour. The line graph shows the accumulated number of the AE occurrences. From the graph in FIG. 5, it can be understood that AE can be sufficiently detected in the early stage of the corrosion. Moreover, the number of the AE occurrences dramatically increased as the oil temperature of the silicone oil circulating through the pipe 10 was increased. Then, after the heating of the silicone oil was continued for a certain time period, the number of the AE occurrences showed a decrease. However, in response to the following temperature drop in the silicone oil, the number of the AE occurrences was increased again. This showed that the number of the AE occurrences per time was increased in response to a change in the dryness (or wetness) of the surface of the piping, and in response to a temperature change.

Furthermore, the occurred AE could be classified into three patterns according to frequencies: over 100 kHz, in a range of 50 kHz to 100 kHz, and in a range of 10 kHz to 50 kHz. Therefore, it was proved that the FOD sensor is sensitive to AE of a wide frequency range.

### Example 2

### Evaluation on Detectable Distance for AE

(1. Preparation of Mock-Up Piping)

In a mock-up piping prepared in the same manner as in Example 1, corrosion was artificially produced and accelerated in the same manner as in Example 1.

(2. Evaluation on AE Detection)

AE detection was evaluated in the same manner as in Example 1, except that the evaluation was carried out on the mock-up piping in the middle stage of the corrosion about 3 months later from the start of the artificial acceleration of the corrosion, and that FOD sensors were firmly attached, by using U-bolts, to a pipe section of the mock-up piping respectively in distances of 2000 mm, 3000 mm, and 3900 mm from the corroded portion (where the pure water was dropped on). Here, it was evaluated whether and how effectively the AE detection could be performed with the FOD sensors so distanced from the corroded portion.

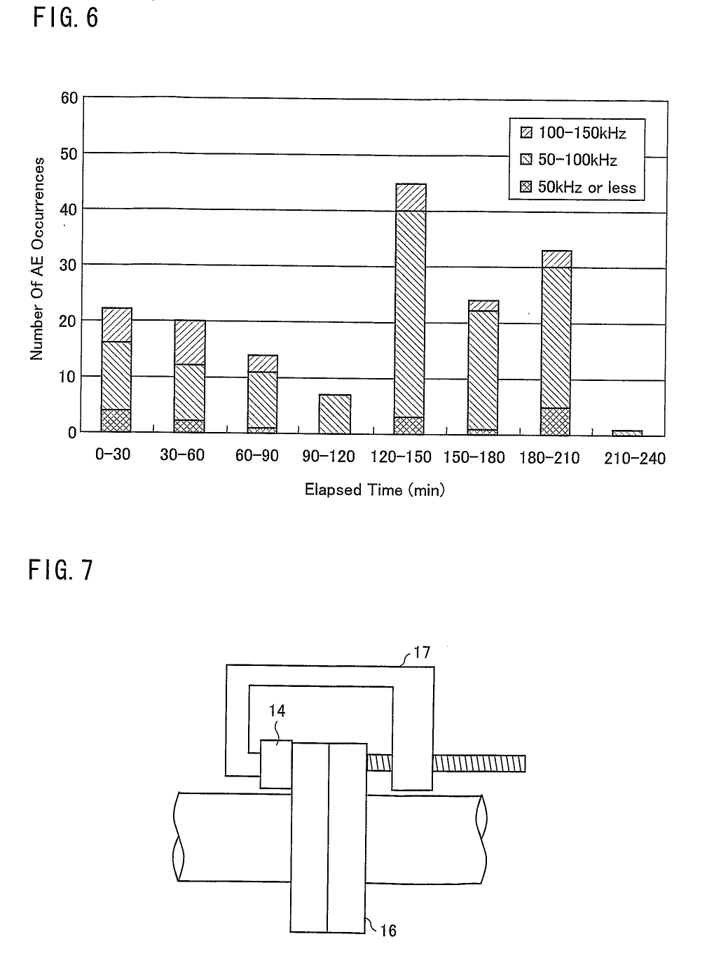

FIG. 6 illustrates the result of the AE detection of the FOD sensor attached in the distance of 3900 mm from the corroded portion. In FIG. 6, the bar graph shows the numbers of AE occurrences per 30 min.

From the graph in FIG. 6, the occurred AE could be classified into 3 patterns according to frequencies: over 100 kHz, in a range of 50 kHz to 100 kHz, and 10 kHz to 50 kHz, again in the medium stage of the corrosion as the result obtained in the early stage of the corrosion in Example 1. It was found that among the three patterns, the frequencies in the range of 50 kHz to 100 kHz were detected more than the others. Furthermore, it was confirmed that AE is detectable with sufficient sensitively even by using the FOD sensor in the farthest distance, that is, the distance of 3900 mm from the corroded portion, as well as by using the FOD sensors in the distances of 2000 mm and 3000 mm from the corroded portion.

### Example 3

### Comparison Between Pipe Section and Flange Section for AE Detection

(1. Preparation of Mock-Up Piping)

In a mock-up piping prepared in the same manner as in Example 1, corrosion was artificially produced and accelerated in the same manner as in Example 1.

(2. Evaluation on AE Detection)

AE detections was evaluated in the same manner as in Example 1, except that the evaluation was carried out on the mock-up piping in the late stage of the corrosion about 5 months later from the start of the artificial acceleration of the corrosion, and that the FOD sensors were attached respectively to a pipe section in the distance of 3900 mm from the corroded portion (where the pure water was dropped on) and to a flange section in the distance of 3950 mm from the corroded portion. The result of the AE detection at the pipe section was compared with the result of the AE detection at the flange section. The FOD sensor attached to the pipe section was firmly attached thereto by using a U-bolt, and the FOD sensor attached to the flange section was firmly attached thereto by using a clamp 17 so that the FOD sensor 14 was attached to that side of the flange section 16 which was closer to the corroded portion, as illustrated in FIG. 7.

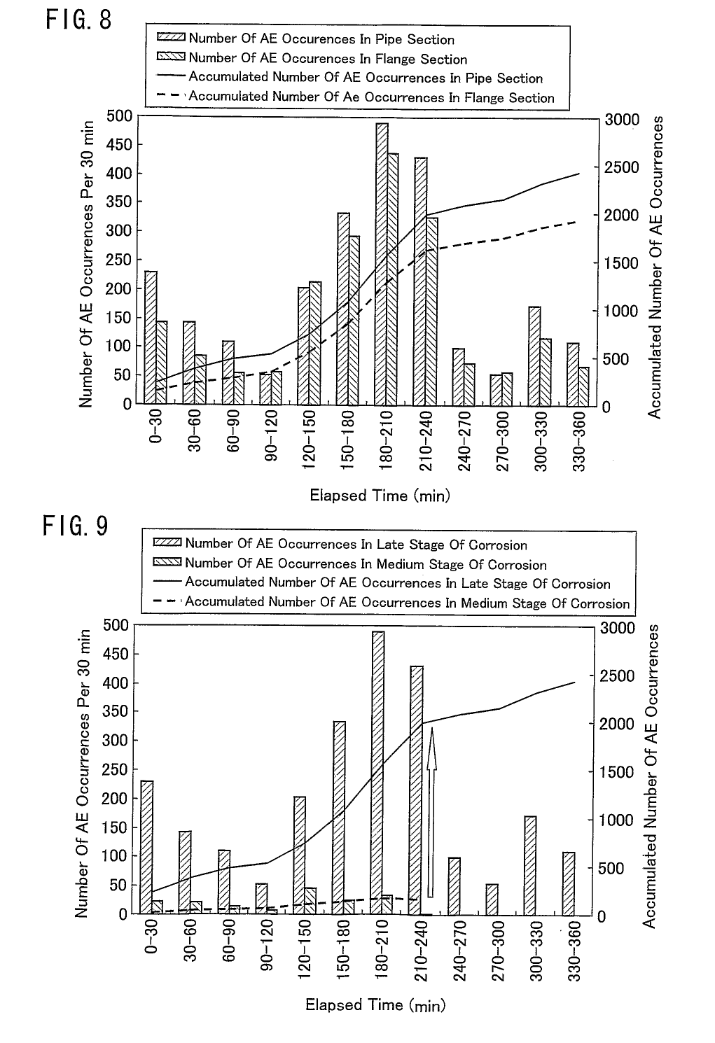

FIG. 8 illustrates a graph in which the results of the AE detections using the FOD sensors attached at the pipe section and the flange section are compared with each other. In FIG. 8, the bar graph shows the number of the AE occurrences per 30 min and the line graph shows the accumulated number of the AE occurrences. From the graph of FIG. 8, it was confirmed that AE can be detected well by using the FOD sensor attached to the flange section, even though the FOD sensor attached to the pipe section was more sensitive than the FOD sensor attached to the flange section.

### Example 4

### Evaluation on Progressive Level of Corrosion, and Number of the AE Occurrences

(1. Preparation of Mock-Up Piping)

In a mock-up piping prepared in the same manner as in Example 1, corrosion was artificially produced and accelerated in the same manner as in Example 1.

(2. Evaluation on AE Detection)

AE detection was evaluated in the same manner as in Example 1, except that the evaluation was carried out on the mock-up piping in the medium stage of the corrosion about 3 months later from the start of the artificial acceleration of the corrosion and on the mock-up piping in the late stage of the corrosion about 5 months later from the start of the artificial acceleration of the corrosion, and that the FOD sensor was firmly attached, by using a U-bolt, to a pipe section in the distance of 3900 mm from the corroded portion (where the pure water was dropped on) in each mock-up piping. The number of the AE occurrences was countered until 360 min from the start of the AE measurement for the mock-up piping in the late stage of the corrosion, while the number of the AE occurrences was countered until only 240 min from the start of the AE measurement for the mock-up piping in the medium stage of the corrosion.

FIG. 9 illustrates a graph in which the number of the AE occurrences in the piping in the medium stage of the corrosion and the number of the AE occurrences in the piping in the late stage of the corrosion are compared with each other. In FIG. 9, the bar graph shows the number of the AE occurrences per 30 min, and the line graph shows the accumulated number of the AE occurrences. Moreover, the arrow indicates a difference between the accumulated number of the AE occurrences in the piping in the late stage of the corrosion and the accumulated number of the AE occurrences in the piping in the medium stage of the corrosion at 240 min from the start of the AE measurement.

From the graph of FIG. 9, the number of the AE occurrences in the piping in the late stage of the corrosion was clearly greater than that in the piping in the medium stage of the corrosion. Especially, the accumulated number of the AE occurrences in the piping in the late stage of the corrosion was approximately 10 times greater than that in the piping in the medium stage of the corrosion at 240 min from the start of the AE detection. This proved that the AE occurrences increased dramatically as the corrosion is in a higher progress level, in other words, as corrosive tubercles increase in volume. From this, it can be understood that the progress level of corrosion can be evaluated by monitoring the accumulated number of AE occurrences that is in some correlation with the progress level of the corrosion.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

According to an inspection method of the present invention for inspecting corrosion under insulation, it is possible to detect the corrosion under insulation efficiently, easily, and economically. Moreover, the inspection method of the present invention allows that AE can be detected with a FOD sensor attached to a flange section of piping. This can make a significant reduction in cost required for removing heat insulators from the piping at installation, maintenance or inspection of the FOD sensor. Furthermore, the inspection method of the present invention makes it possible to evaluate the corrosion in terms of its progress level by monitoring the accumulated number of AE occurrences. FOD sensors can be constantly provided to chemical plants having large-scale piping facilities and further to plants having an explosion-proof area (such as petrochemical plants) because they are explosion-proof sensors with good durability. Therefore, the present invention is appropriately applicable to various industries in which inspection on corrosion under insulation is required.

### REFERENCE SIGNS LIST

1 Optical Fiber
2 Light Source
3 Fiber Optical Doppler Sensor (FOD sensor)
4 Optical Fiber
5 Light Source
6 Detector
7 AOM
8 Half Mirror
9 Half Mirror
10 Pipe
11 Dropping Device
12 Heating Device
13 Heat insulator
14 Fiber Optical Doppler Sensor (FOD sensor)
16 Flange Section
17 Clamp

1. An inspection method for inspecting corrosion under insulation, in piping to which a heat insulator is provided, the method comprising:
providing a fiber optical Doppler sensor to the piping; and
inspecting the corrosion in the piping by using the fiber optical Doppler sensor.

2. The inspection method as set forth in claim 1, wherein the fiber optical Doppler sensor is provided to a flange section of the piping.

3. The inspection method as set forth in claim 1, wherein a plurality of the fiber optical Doppler sensors are provided to the piping.

4. The inspection method as set forth in claim 1, wherein the fiber optical Doppler sensor detects acoustic emission of frequencies in a range of 10 kHz to 150 kHz.

5. The inspection method as set forth in claim 1, comprising:
monitoring an accumulated number of acoustic emission occurrences, so as to evaluate a progress level of the corrosion.
